(19) United States
(12) Patent Application Publication
(10) Pub. No.: US 2017/0235462 A1
(43) Pub. Date: Aug. 17, 2017

(54) INTERACTION CONTROL METHOD AND ELECTRONIC DEVICE FOR VIRTUAL REALITY

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Zheng Zhou, Tianjin (CN)

(21) Appl. No.: 15/237,656

(22) Filed: Aug. 16, 2016

Related U.S. Application Data
(63) Continuation of application No. PCT/CN2016/088582, filed on Jul. 5, 2016.

(30) Foreign Application Priority Data
Feb. 16, 2016 (CN) 201610087957.3

(51) Int. Cl. G06F 3/0484; G06F 3/0481; G06F 3/01

(52) U.S. Cl. CPC G06F 3/04842; G06F 3/013; G06F 3/012; G06F 3/04817; G06F 3/04812

(57) ABSTRACT

The disclosure provides an interaction control method and electronic device for virtual reality. The method includes: if it is detected that the time a locating crosshair stays on an operation object is greater than or equal to a preset time value, displaying a selection interface corresponding to the operation object, the selection interface containing a first area configured to confirm the selection of the operation object and a second area configured to cancel the selection of the operation object; determining whether a user selects the first area or the second area according to the acquired head movement data of the user or the acquired eye data of the user; if it is determined that the user selects the first area, selecting the operation object; if it is determined that the user selects the second area, closing the selection interface.

### CROSS REFERENCE TO RELATED APPLICATIONS

This application is a continuation of International Application No. PCT/CN2016/088582 filed on Jul. 5, 2016, which claims priority to Chinese Patent Application No. 201610087957.3 entitled “INTERACTION CONTROL METHOD AND DEVICE FOR VIRTUAL REALITY”, filed before China's State Intellectual Property Office on Feb. 16, 2016, the entire contents of which are incorporated herein by reference.

### TECHNICAL FIELD

The disclosure pertains to the technical field of virtual reality, and specifically pertains to an interaction control method and an interaction control electronic device for virtual reality.

### BACKGROUND

The virtual reality interaction technology is a newly emerging comprehensive information technology, which adopts the modern high technology with computer as a kernel to generate a vivid virtual environment in a specific scope with visual sense, audio sense and touch sense integrated and in which a user interacts and interplays with an object in the virtual environment in a natural manner by means of necessary devices to get a feeling and experience of real environment equivalent to visit in person. The virtual reality interaction technology combines with a variety of information technologies including data image processing, multimedia technology, computer graphics and sensor technology, and constructs a three-dimensional digital model through the computer graphics to present a three-dimensional virtual environment to a user in sight sense. Different from a common three-dimensional model generated by a Computer Aided Design (CAD) system, the three-dimensional digital model generated by the virtual reality interaction technology is not a static environment but an interactive environment.

At present, there have been virtual reality glasses, through which a user can watch 3D (Three-Dimensional) videos, play virtual reality games and enjoy virtual scenic spots on a terminal with a display screen, such as smart phone and tablet computer. This has become a tendency, and this type of good immersive experience makes virtual reality glasses applauded by more and more consumers.

In particular, a user can control the content displayed on the display interface of the virtual reality glasses through sight, for example, a user can stay the sight on a selected icon or button for more than a preset time on the interface, so as to start the application corresponding to the icon or accomplish the operation of clicking the button; generally, the time is relatively long, about 3 s to 5 s.

However, the inventors have found that during the implementation of the disclosure, the present interaction mode is passive reception for users; the user probably does not want to start the application corresponding to the icon or accomplish the operation of clicking the button, thus the error rate of operation is high and user experience is poor.

### SUMMARY

The disclosure provides an interaction control method and an interaction control electronic device for virtual reality, so as to solve the problems of high error rate of operation and poor user experience in existing technologies.

The first aspect of the embodiments of the disclosure provides an interaction control method for virtual reality, which is applied to a head-mounted display device, including:

if it is detected that the time a locating crosshair stays on an operation object on a virtual reality display interface is greater than or equal to a preset time value, displaying a selection interface corresponding to the operation object, the selection interface containing a first area configured to confirm the selection of the operation object and a second area configured to cancel the selection of the operation object;

determining whether a user selects the first area or the second area according to the acquired head movement data of the user or the acquired eye image data of the user;

if it is determined that the user selects the first area, performing the selection of the operation object; and

if it is determined that the user selects the second area, closing the selection interface.

The second aspect of the embodiments of the disclosure provides an interaction control electronic device for virtual reality, including:

one or more processors; and

a memory; wherein,

the memory is stored with instructions executable by the one or more processors, the instructions are configured to execute:

if it is detected that the time a locating crosshair stays on an operation object on a virtual reality display interface is greater than or equal to a preset time value, displaying a selection interface corresponding to the operation object, the selection interface containing a first area configured to confirm the selection of the operation object and a second area configured to cancel the selection of the operation object;

determining whether a user selects the first area or the second area according to the acquired head movement data of the user or the acquired eye image data of the user;

if it is determined that the user selects the first area, performing the selection of the operation object; and

if it is determined that the user selects the second area, closing the selection interface.

The third aspect of the embodiments of the disclosure provides a nonvolatile computer storage media, which has computer executable instructions stored thereon, wherein the computer executable instructions are configured to:

if it is detected that the time a locating crosshair stays on an operation object on a virtual reality display interface is greater than or equal to a preset time value, display a selection interface corresponding to the operation object, the selection interface containing a first area configured to confirm the selection of the operation object and a second area configured to cancel the selection of the operation object;

determine whether a user selects the first area or the second area according to the acquired head movement data of the user or the acquired eye image data of the user;

if it is determined that the user selects the first area, perform the selection of the operation object; and

if it is determined that the user selects the second area, close the selection interface.

From the above embodiments of the disclosure, it can be known that, if it is detected that the time a locating crosshair stays on an operation object on a virtual reality display interface is greater than or equal to a preset time value, a selection interface corresponding to the operation object is displayed, the selection interface containing a first area configured to confirm the selection of the operation object and a second area configured to cancel the selection of the operation object; then it is determined whether a user selects the first area or the second area according to the acquired head movement data of the user or the acquired eye image data of the user; if it is determined that the user selects the first area, the operation object is selected; and if it is determined that the user selects the second area, the selection interface is closed. Different from the existing technology, the disclosure displays a selection interface when it is detected that the time a locating crosshair stays on an operation object on a virtual reality display interface is greater than or equal to a preset time value; moreover, a user may select the first area or the second area through the head or eyes, so as to further confirm whether to select the operation object through the head or eyes, thereby realizing the interaction between the user and the virtual reality display interface; the disclosure can effectively improve the accuracy of a user selecting an operation object, which more fulfills the selection intention of the user and improves the user experience.

### BRIEF DESCRIPTION OF THE DRAWINGS

For a better understanding of the embodiments of the disclosure or the technical scheme of the existing technology, a brief introduction is given below to the drawings needed in the description of the embodiments or existing technology. Obviously, the following drawings are some embodiments of the disclosure simply; for those skilled in the art, other drawings can be obtained according to these drawings without creative work.

FIG. 1 is a flowchart illustrating an interaction control method for virtual reality in the first embodiment of the disclosure.

FIG. 2a is a diagram of a selection interface in the embodiment of the disclosure.

FIG. 2b is a diagram of a selection interface in the embodiment of the disclosure.

FIG. 3 is a flowchart illustrating the detailed steps of S102 in the first embodiment shown in FIG. 1.

FIG. 4a is a diagram of FIG. 2a added with a direction arrow.

FIG. 4b is a diagram of FIG. 2b added with a direction arrow.

FIG. 5 is a flowchart illustrating the detailed steps of 102 in the first embodiment shown in FIG. 1.

FIG. 6 is a diagram of function modules of an interaction control device for virtual reality in the second embodiment of the disclosure.

FIG. 7 is a diagram of detailed function modules of a determination module 602 in the second embodiment shown in FIG. 6.

FIG. 8 is a diagram of detailed function modules of a determination module 602 in the second embodiment shown in FIG. 6.

FIG. 9 is a schematic diagram of a structure of an hardware of the electronic device of the interaction control method for virtual reality according to a third embodiment of the disclosure.

### DESCRIPTION OF THE EMBODIMENTS

To make the purpose, the features and the benefits of the disclosure more apparent and understandable, a clear and complete description is provided to the technical scheme in the embodiments of the disclosure in conjunction with the drawings in the embodiments of the disclosure. Obviously, the embodiments described hereinafter are simply part embodiments of the disclosure, but all the embodiments. All other embodiments obtained by those skilled in the art based on the embodiments in the disclosure without creative work are intended to be included in the scope of protection of the disclosure.

The disclosure provides an interaction control method and an interaction control electronic device for virtual reality, so as to solve the problems of high error rate of operation and poor user experience in existing technologies.

Please refer to FIG. 1, which is a flowchart illustrating an interaction control method for virtual reality in the first embodiment of the disclosure, including:

S101: if it is detected that the time a locating crosshair stays on an operation object on a virtual reality display interface is greater than or equal to a preset time value, displaying a selection interface corresponding to the operation object, the selection interface containing a first area configured to confirm the selection of the operation object and a second area configured to cancel the selection of the operation object.

In the embodiment of the disclosure, when using a virtual reality system, a user may wear a virtual reality headset or a pair of virtual reality glasses on the head or eyes and control the display interface of the virtual reality headset or virtual reality glasses through the head or eyes.

In the embodiment of the disclosure, it is an interaction control device for virtual reality that implements the interaction control method for virtual reality provided in the disclosure, and the interaction control device for virtual reality (hereinafter called a control device) is one part of a virtual reality system, specifically it may be one part of a virtual reality headset or a pair of virtual reality glasses. This control device can control the virtual reality display interface through head or eyes.

In particular, the control device can detect the time a locating crosshair stays on an operation object on a virtual reality display interface; if the time is greater than a preset time value, the control device displays a selection interface corresponding to the operation object, which, for the convenience of selection by a user, contains a first area configured to confirm the selection of the operation object and a second area configured to cancel the selection of the operation object.

In particular, the operation object refers to a selectable object on the display interface, which, after selected, can be started or triggered to execute a corresponding function or enter a corresponding page.

Preferably, the operation object may be an icon of an application, a virtual button, an action bar, an icon of a video file, an icon of an audio file or an icon of a text file and the like.

In the embodiment of the disclosure, the locating crosshair may be controlled through head or eyes. A user can switch between the head control and the eyes control through a preset switching operation.

It should be noted that in the embodiment of the disclosure a device capable of tracking the locating crosshair has been set in the virtual reality system, for example, in the scene of eyes control, an image collection device, which is capable of collecting the eye image of a user and sending the collected eye image of the user to the control device, is set on a virtual reality headset or a pair of virtual reality glasses, wherein the control device can process the collected eye image of the user by an eye tracking technique, determine the current position of the locating crosshair on the virtual reality display interface, determine the operation object at the position where the locating crosshair stays and determine the time the locating crosshair stays on the operation object. Therefore, the control device can determine the time the locating crosshair stays on an operation object on a virtual reality display interface.

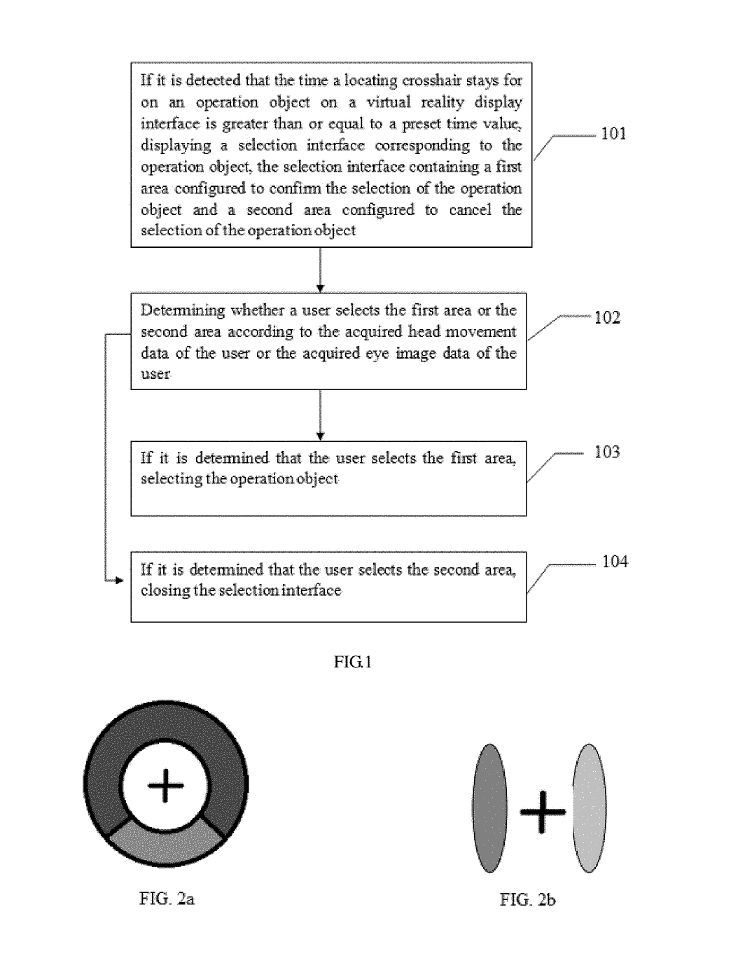

It should be noted that in the embodiment of the disclosure, when the selection interface is displayed on the virtual reality display interface, the first area and the second area in the selection interface may be presented in many feasible modes, for example, please refer to FIG. 2a, which is a diagram of a selection interface in the embodiment of the disclosure, in particular, the selection interface may be circular-ring shaped, the cross in the centre of the circular-ring shape is the locating crosshair, the 90-degree area below the circular ring is the first area and the rest area is the second area. The circular-ring shape is one of the shapes that can be adopted; during actual application, the first area and the second area also may be set as other enclosed shapes, for example, triangle, quadrangle and the like. Alternatively, please refer to FIG. 2b, which is a diagram of a selection interface in the embodiment of the disclosure, in the selection interface the first area is on the left and the second area is one the right, the cross between the first area and the second area is the locating crosshair; in FIG. 2b, the first area and the second area are presented in a manner of left right arrangement; during actual application, the arrangement mode is not limited for the first area and the second area, for example, the first area and the second area also may be presented in a manner of top down arrangement, in a manner of diagonal arrangement, in a manner of one horizontal and one vertical arrangement, or in a manner of any other arrangements, which is not limited here.

It should be noted that, during actual application, a text prompt message may be displayed in the first area and second area to facilitate the understanding of users, for example, “Confirm” is displayed in the first area and “Cancel” is displayed in the second area. Further, the first area and the second area may be filled with different colors for distinguishing.

In particular, the selection interface may be displayed on the display interface in the form of a little window, or displayed in a manner of full-screen overriding to override all contents displayed on the display interface.

S102: determining whether a user selects the first area or the second area according to the acquired head movement data of the user or the acquired eye data of the user; continuing to execute S103 or S104.

S103: if it is determined that the user selects the first area, selecting the operation object.

S104: if it is determined that the user selects the second area, closing the selection interface.

In the embodiment of the disclosure, a user can determine whether to select the first area or the second area through the head or eyes; after the control device displays the selection interface on the virtual reality display interface, the control device acquires in real time the head movement data of the user or the eye date of the user and determine whether the user selects the first area or the second area according to the acquired head data of the user or the acquired eye data of the user.

In the embodiment of the disclosure, if it is determined that the user selects the first area, it is determined that the user needs to operate the operation object, then the control device selects the operation object. If it is determined that the user selects the second area, it is determined that the user does not need to operate the operation object, then the control device closes the selection interface.

In the embodiment of the disclosure, for different operation objects, the specific operation to select the operation object is different too; in particular:

if the operation object is an icon of an application, the control device starts the application; for example, if the operation object is an icon of a video client, the control device starts the video client and displays on the virtual reality display interface the home page of the started video client.

If the operation object is a virtual button or an action bar, the control device simulates the operation of clicking the virtual button or action bar, so as to realize the function of clicking the virtual button or the function of clicking the action bar.

If the operation object is an icon of a video file, an icon of an audio file or an icon of a text file, the control device plays the video file or the audio file, or opens the text file.

It should be noted that a device capable of detecting the head movement data or eye data of a user has been set in the virtual reality system, for example, in the scene of head control, a head movement sensor, which senses the head movement of a user and sends the collected head movement data of the user to the control device, may be set on a virtual reality headset or a pair of virtual reality glasses, wherein the control device can process the collected head movement data of the user so as to determine the track of the head movement of the user and control the position of the locating crosshair on the virtual reality display interface based on the track of the head movement, the track of the head movement of the user including the movement direction of the head, the movement distance of the head and the like.

In the embodiment of the disclosure, if it is detected that the time a locating crosshair stays on an operation object on a virtual reality display interface is greater than or equal to a preset time value, a selection interface corresponding to the operation object is displayed, the selection interface containing a first area configured to confirm the selection of the operation object and a second area configured to cancel the selection of the operation object; then, it is determined whether a user selects the first area or the second area according to the acquired head movement data of the user or the acquired eye image data of the user; if it is determined that the user selects the first area, the operation object is selected; and if it is determined that the user selects the second area, the selection interface is closed; this allows a user to further confirm whether to select an operation object through the head or eyes, thereby realizing the interaction between the user and the virtual reality display interface, and, this can effectively improve the accuracy of a user selecting an operation object, which more fulfills the selection intention of the user and improves the user experience.

Preferably, in the first embodiment shown in FIG. 1, the preset time value is 1 s to 2 s, so as to solve the problem in the existing technology that anxiety and disgust are caused to a user because the user needs to stay the locating crosshair at an operation object for a long time (3 s to 5 s). In the embodiment of the disclosure, if the preset time is set to 2 s, when the control device detects that the time the locating crosshair stays on an operation object is equal to or greater than 2 s, the control device displays a selection interface and determines through the head or eyes of the user whether to select the operation object; this not only can reduce the anxiety or disgust of the user, but also can enhance the interaction between the user and the virtual reality display interface and improve user experience.

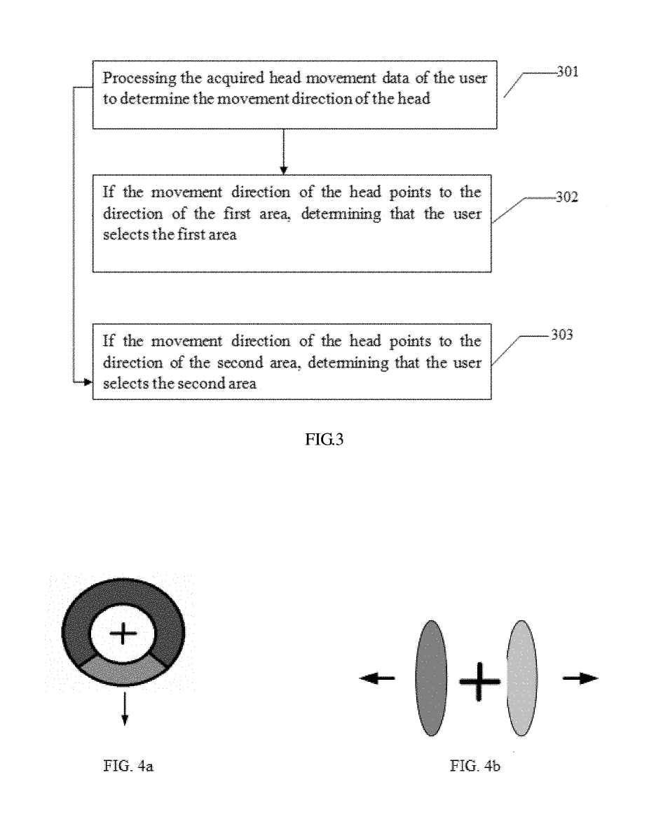

Please refer to FIG. 3, which is a flowchart illustrating the detailed steps of determining whether a user selects the first area or the second area according to the acquired head movement data of the user in S102 in the first embodiment shown in FIG. 1, including:

S301: processing the acquired head movement data of the user to determine the movement direction of the head.

In the embodiment of the disclosure, the device set in the virtual reality system for collecting the head movement data of a user acquires the head movement data of the user in real time and sends the acquired head movement direction of the user to the control device, which then processes the acquired head movement data of the user to determine the movement direction of the head.

In particular, the control device compares the determined head movement direction of the user with the direction of the first area and the direction of the second area, to determine whether the user selects the first area or the second area.

S302: if the movement direction of the head points to the direction of the first area, determining that the user selects the first area.

S303: if the movement direction of the head points to the direction of the second area, determining that the user selects the second area.

In the embodiment of the disclosure, if the control device determines that the movement direction of the head points to the direction of the first area, the control device determines that the user selects the first area; if the control device determines that the movement direction of the head points to the direction of the second area, the control device determines that the user selects the second area.

In particular, the direction of the first area refers to the direction division formed based on the positions of the first area and the second area displayed on the display interface. For example, if the first area and the second area are as shown in FIG. 2a, the direction of the first area is within the 90-degree scope below the first area. If a user nods, the head movement direction of the user is downwards, pointing to the direction of the first area, then it can be determined that the user selects the first area.

One more example, if the first area and the second area are as shown in FIG. 2b, the direction of the first area is the left side of the first area, and the direction of the second area is the right side of the second area. If the head of a user moves rightwards, it is determined that the head movement direction of the user is toward the right, pointing to the direction of the second area, then it can be determined that the user selects the second area.

It should be noted that, in order to better guide a user to determine through the head the area to be selected, the direction of the first area and the direction of the second area may be presented on the display interface in the form of direction arrows when the control device displays a selection interface on the virtual reality display interface, so that the user can quickly learn how to realize the selection of the first area or the selection of the second area. Please refer to FIG. 4a, which is a diagram of FIG. 2a added with a direction arrow, in particular, the first area is added with a direction arrow; please refer to FIG. 4b, which is a diagram of FIG. 2b added with a direction arrow, in particular, the first area is added with a leftward direction arrow and the second area is added with a rightward direction arrow; through the indication of the direction arrow, a user can become more clear about the movement mode of the head, with user experience improved.

In the embodiment of the disclosure, when a user controls through the head the selection of the first area and the second area on the selection interface, the control device processes the acquired head movement data of the user to determine the movement direction of the head; if the movement direction of the head points to the direction of the first area, the control device determines that the user selects the first area; if the movement direction of the head points to the direction of the second area, the control device determines that the user selects the second area; this allows a user to realize the selection of the first area or the second area through the selection by the head, thereby realizing the interaction between the user and the virtual reality display interface, and, this determines the operation object the user actually needs to select, thereby effectively reducing the error rate of the selection by the user and improving user experience.

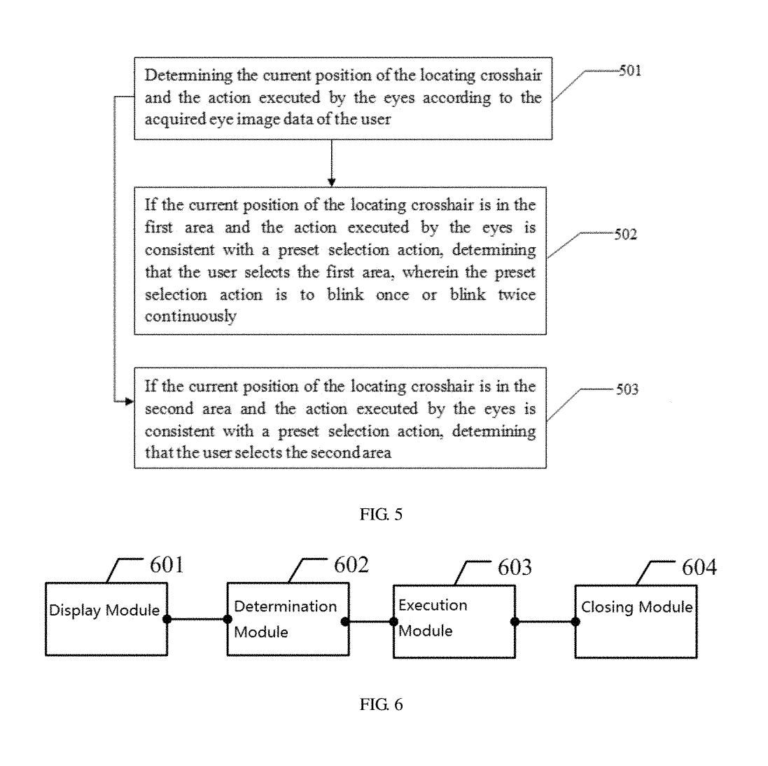

Please refer to FIG. 5, which is a flowchart illustrating the detailed steps of determining whether a user selects the first area or the second area according to the acquired eye image data of the user in S102 in the first embodiment shown in FIG. 1, including:

S501: determining the current position of the locating crosshair and the action executed by the eyes according to the acquired eye image data of the user; executing S502 or S503 respectively.

In the embodiment of the disclosure, an image collection device capable of collecting the eye image data of a user has been set in the virtual reality system; after collecting the eye image data of a user, the image collection device sends the eye image data to the control device, which then determines the current position of the locating crosshair and the action executed by the eyes according to the eye image data.

S502: if the current position of the locating crosshair is in the first area and the action executed by the eyes is consistent with a preset selection action, determining that the user selects the first area, wherein the preset selection action is to blink once or blink twice continuously.

S503: if the current position of the locating crosshair is in the second area and the action executed by the eyes is consistent with a preset selection action, determining that the user selects the second area.

In the embodiment of the disclosure, after the control device determines the current position of the locating crosshair and the action executed by the eye, if the current position of the locating crosshair is in the first area and the action executed by the eyes is consistent with a preset selection action, the control device determines that the user selects the first area, wherein the preset selection action is to blink once or blink twice continuously. It should be noted that other actions of eyes also may be set as the selection action in advance and no limitation is made here.

For example, taking FIG. 2b for example, if it is detected that the locating crosshair is in the first area and the user executes the preset operation of blinking twice continuously when the locating crosshair is in the first area, it is determined that the user selects the first area.

In the embodiment of the disclosure, if the current position of the locating crosshair is in the second area and the action executed by the eyes is consistent with a preset selection action, it is determined that the user selects the second area.

It should be noted that, within the preset time, if no locating crosshair has been detected in the first area or the second area, or no preset selection action has been detected executed by the eyes of the user, the control device closes the selection interface after the preset time is ended.

In the embodiment of the disclosure, the control device determines the current position of the locating crosshair and the action executed by the eyes according to the acquired eye image data of the user; if the current position of the locating crosshair is in the first area and the action executed by the eyes is consistent with a preset selection action, the control device determines that the user selects the first area; if the current position of the locating crosshair is in the second area and the action executed by the eyes is consistent with a preset selection action, the control device determines that the user selects the second area. This allows a user to control the virtual reality display interface through the eyes, thereby realizing the interaction between the user and the virtual reality, and, this can determine the operation object the user actually needs to select, thereby effectively reducing the error rate of the selection by the user and improving user experience.

Please refer to FIG. 6, which is a diagram of function modules of an interaction control device for virtual reality in the second embodiment of the disclosure, including:

a display module 601, which is configured to display a selection interface corresponding to an operation object if it is detected that the time a locating crosshair stays on the operation object on a virtual reality display interface is greater than or equal to a preset time value, the selection interface containing a first area configured to confirm the selection of the operation object and a second area configured to cancel the selection of the operation object.

In the embodiment of the disclosure, the interaction control device for virtual reality (hereinafter called a control device) is one part of a virtual reality system, specifically one part of a virtual reality headset or a pair of virtual reality glasses. This control device can control the virtual reality display interface through head or eyes.

In particular, the control device can detect the time a locating crosshair stays on an operation object on a virtual reality display interface; if the time is greater than a preset time value, the display module 601 displays a selection interface corresponding to the operation object, which, for the convenience of selection by a user, contains a first area configured to confirm the selection of the operation object and a second area configured to cancel the selection of the operation object.

In particular, the operation object refers to a selectable object on the display interface, which, after selected, can be started or triggered to execute a corresponding function or enter a corresponding page.

Preferably, the operation object may be an icon of an application, a virtual button, an action bar, an icon of a video file, an icon of an audio file or an icon of a text file and the like.

It should be noted that in the embodiment of the disclosure a device capable of tracking the locating crosshair has been set in the virtual reality system, for example, in the scene of eyes control, an image collection device, which is capable of collecting the eye image of a user and sending the collected eye image of the user to the control device, may be set on a virtual reality headset or a pair of virtual reality glasses, wherein the control device can process the collected eye image of the user by an eye tracking technique, determine the position of the locating crosshair on the virtual reality display interface according to the processed data, determine the operation object at the position where the locating crosshair stays according to the position of the locating crosshair and determine the time the locating crosshair stays on the operation object according to the processed data. Therefore, the control device can determine the time the locating crosshair stays on an operation object on the virtual reality display interface.

It should be noted that in the embodiment of the disclosure, when the selection interface is displayed on the virtual reality display interface, the first area and the second area in the selection interface may be presented in many feasible modes, for example, please refer to FIG. 2a, which is a diagram of a selection interface in the embodiment of the disclosure; in particular, the selection interface may be circular-ring shaped, and the 90-degree area below the circular ring is the first area and the rest area is the second area. The circular-ring shape is one of the shapes that can be adopted; during actual application, the first area and the second area also may be set as other enclosed shapes, for example, triangle, quadrangle and the like. Or, please refer to FIG. 2b, which is a diagram of a selection interface in the embodiment of the disclosure; in the selection interface, the first area is on the left and the second area is one the right; in FIG. 2b, the first area and the second area are presented in a manner of left right arrangement; during actual application, the arrangement mode is not limited for the first area and the second area, for example, the first area and the second area also may be presented in a manner of top down arrangement, in a manner of diagonal arrangement, in a manner of one horizontal and one vertical arrangement, or in a manner of any other arrangements, which is not limited here.

It should be noted that, during actual application, a text prompt message may be displayed in the first area and second area to facilitate the understanding of users, for example, “Confirm” is displayed in the first area and “Cancel” is displayed in the second area. Further, the first area and the second area may be filled with different colors for distinguishing.

In particular, the selection interface may be displayed on the display interface in the form of a little window, or displayed in a manner of full-screen overriding to override all contents displayed on the display interface.

A determination module 602, which is configured to determine whether a user selects the first area or the second area according to the acquired head movement data of the user or the acquired eye image data of the user.

An execution module 603, which is configured to select the operation object if it is determined that the user selects the first area.

A closing module 604, which is configured to close the selection interface if it is determined that the user selects the second area.

In the embodiment of the disclosure, if the operation object is an icon of an application, the execution module 603 starts the application; for example, if the operation object is an icon of a video client, the execution module 603 starts the video client and displays on the virtual reality display interface the home page of the started video client.

If the operation object is a virtual button or an action bar, the execution module 603 simulates the operation of clicking the virtual button or action bar.

If the operation object is an icon of a video file, an icon of an audio file or an icon of a text file, the execution module 603 plays the video file or the audio file, or opens the text file.

It should be noted that a device capable of detecting the head movement data or eye data of a user has been set in the virtual reality system, for example, a head movement sensor, which senses the head movement of a user and sends the collected head movement data of the user to the control device, may be set on a virtual reality headset or a pair of virtual reality glasses, wherein the control device can process the collected head movement data of the user so as to determine the track of the head movement of the user, the track of the head movement of the user including the movement direction of the head, the movement distance of the head and the like.

In the embodiment of the disclosure, if it is detected that the time a locating crosshair stays on an operation object on a virtual reality display interface is greater than or equal to a preset time value, the display module 601 displays a selection interface corresponding to the operation object, the selection interface containing a first area configured to confirm the selection of the operation object and a second area configured to cancel the selection of the operation object; then, the determination module 602 determines whether a user selects the first area or the second area according to the acquired head movement data of the user or the acquired eye image data of the user; if it is determined that the user selects the first area, the execution module 603 selects the operation object; and if it is determined that the user selects the second area, the closing module 604 closes the selection interface; this allows a user to further confirm whether to select an operation object through the head or eyes, thereby realizing the interaction between the user and the virtual reality display interface, and, this can effectively improve the accuracy of a user selecting an operation object, which more fulfills the selection intention of the user and improves the user experience.

Preferably, in the second embodiment shown in FIG. 6, the preset time value is 1 s to 2 s, so as to solve the problem in the existing technology that anxiety and disgust are caused to a user because the user needs to stay the locating crosshair at an operation object for a long time (3 s to 5 s). In the embodiment of the disclosure, if the preset time is set to 2 s, when the control device detects that the time the locating crosshair stays on an operation object is equal to or greater than 2 s, the display module 601 displays a selection interface and determines through the head or eyes of the user whether to select the operation object; this not only can reduce the anxiety or disgust of the user, but also can enhance the interaction between the user and the virtual reality display interface and improve user experience.

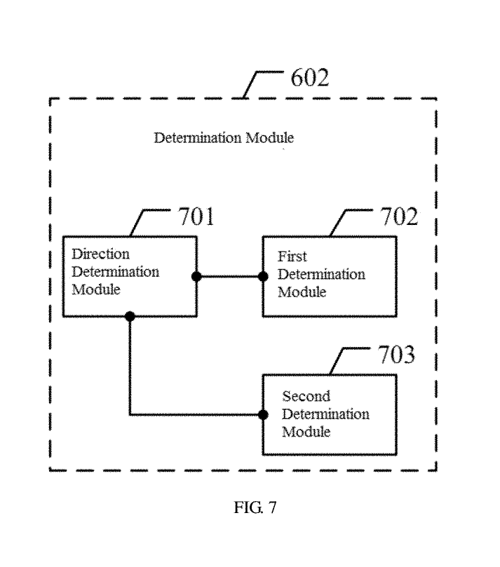

Please refer to FIG. 7, which is a diagram of detailed function modules of a determination module 602 in the second embodiment shown in FIG. 6, including:

a direction determination module 701, which is configured to process the acquired head movement data of the user to determine the movement direction of the head.

In the embodiment of the disclosure, the device set in the virtual reality system for collecting the head movement data of a user acquires the head movement data of the user in real time and sends the acquired head movement direction of the user to the control device; then the direction determination module 701 processes the acquired head movement data of the user to determine the movement direction of the head.

In particular, the direction determination module 701 compares the determined head movement direction of the user with the direction of the first area and the direction of the second area, to determine whether the user selects the first area or the second area.

A first determination module 702, which is configured to determine that the user selects the first area if the movement direction of the head points to the direction of the first area.

A second determination module 703, which is configured to determine that the user selects the second area if the movement direction of the head points to the direction of the second area.

In the embodiment of the disclosure, if the direction determination module 701 determines that the movement direction of the head points to the direction of the first area, the first determination module 702 determines that the user selects the first area; if the direction determination module 701 determines that the movement direction of the head points to the direction of the second area, the second determination module 703 determines that the user selects the second area.

In particular, the direction of the first area refers to the direction division formed based on the positions of the first area and the second area displayed on the display interface. For example, if the first area and the second area are as shown in FIG. 2a, the direction of the first area is within the 90-degree scope below the first area. If a user nods, the head movement direction of the user is downwards, pointing to the direction of the first area, then it can be determined that the user selects the first area.

One more example, if the first area and the second area are as shown in FIG. 2b, the direction of the first area is the left side of the first area, and the direction of the second area is the right side of the second area. If the head of a user moves rightwards, it is determined that the head movement direction of the user is toward the right, pointing to the direction of the second area, then it can be determined that the user selects the second area.

It should be noted that, in order to better guide a user to determine through the head the area to be selected, the direction of the first area and the direction of the second area may be presented on the display interface in the form of direction arrows when the display module 601 displays a selection interface on the virtual reality display interface, so that the user can quickly learn how to realize the selection of the first area or the selection of the second area. Please refer to FIG. 4a, which is a diagram of FIG. 2a added with a direction arrow, in particular, the first area is added with a direction arrow; please refer to FIG. 4b, which is a diagram of FIG. 2b added with a direction arrow, in particular, the first area is added with a leftward direction arrow and the second area is added with a rightward direction arrow; through the indication of the direction arrow, a user can become more clear about the movement mode of the head, with user experience improved.

In the embodiment of the disclosure, the direction determination module 701 processes the acquired head movement data of the user to determine the movement direction of the head; if the movement direction of the head points to the direction of the first area, the first determination module 702 determines that the user selects the first area; if the movement direction of the head points to the direction of the second area, the second determination module 703 determines that the user selects the second area; this allows a user to realize the selection of the first area or the second area through the selection by the head, thereby realizing the interaction between the user and the virtual reality display interface, and, this determines the operation object the user actually needs to select, thereby effectively reducing the error rate of the selection by the user and improving user experience.

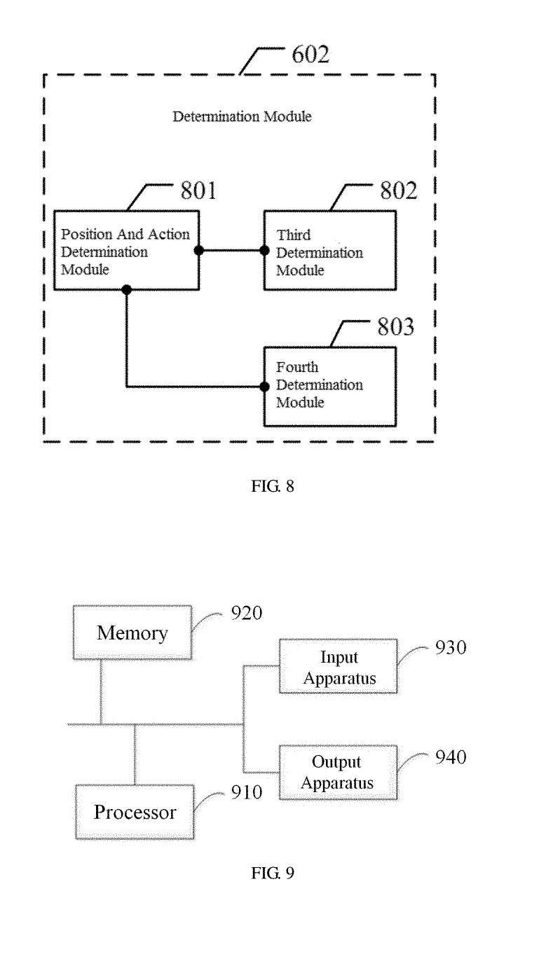

Please refer to FIG. 8, which is a diagram of detailed function modules of a determination module 602 in the second embodiment shown in FIG. 6, including:

a position and action determination module 801, which is configured to determine the current position of the locating crosshair and the action executed by the eyes according to the acquired eye image data of the user.

In the embodiment of the disclosure, an image collection device capable of collecting the eye image data of a user has been set in the virtual reality system; after collecting the eye image data of a user, the image collection device sends the eye image data to the control device, the position and action determination module 801 in which then determines the current position of the locating crosshair and the action executed by the eyes according to the eye image data.

A third determination module 802, which is configured to determine that the user selects the first area if the current position of the locating crosshair is in the first area and the action executed by the eyes is consistent with a preset selection action, wherein the preset selection action is to blink once or blink twice continuously.

A fourth determination module 803, which is configured to determine that the user selects the second area if the current position of the locating crosshair is in the second area and the action executed by the eyes is consistent with a preset selection action.

In the embodiment of the disclosure, after the position and action determination module 801 determines the current position of the locating crosshair and the action executed by the eye, if the current position of the locating crosshair is in the first area and the action executed by the eyes is consistent with a preset selection action, the third determination module 802 determines that the user selects the first area, wherein the preset selection action is to blink once or blink twice continuously. It should be noted that other actions of eyes also may be set as the selection action in advance and no limitation is made here.

For example, taking FIG. 2b for example, if it is detected that the locating crosshair is in the first area and the user executes the preset operation of blinking twice continuously when the locating crosshair is in the first area, it is determined that the user selects the first area.

In the embodiment of the disclosure, if the current position of the locating crosshair is in the second area and the action executed by the eyes is consistent with a preset selection action, the fourth determination module 803 determines that the user selects the second area.

It should be noted that, within the time preset, if no locating crosshair has been detected in the first area or the second area, or no preset selection action has been detected executed by the eyes of the user, the control device closes the selection interface after the preset time is ended.

In the embodiment of the disclosure, the position and action determination module 801 determines the current position of the locating crosshair and the action executed by the eyes according to the acquired eye image data of the user; if the current position of the locating crosshair is in the first area and the action executed by the eyes is consistent with a preset selection action, the third determination module 802 determines that the user selects the first area; if the current position of the locating crosshair is in the second area and the action executed by the eyes is consistent with a preset selection action, the fourth determination module 803 determines that the user selects the second area. This allows a user to control the virtual reality display interface through the eyes, thereby realizing the interaction between the user and the virtual reality, and, this can determine the operation object the user actually needs to select, thereby effectively reducing the error rate of the selection by the user and improving user experience.

It should be noted that, during actual application, the determination module 602 may include the function modules in the embodiment shown in FIG. 7 and the function modules in the embodiment shown in FIG. 8 simultaneously.

The embodiments of the disclosure application provide a nonvolatile computer storage media having computer executable instructions stored thereon, wherein the computer executable instructions can perform the interaction control processing method for virtual reality in any one of the foregoing embodiments of methods.

FIG. 9 is a schematic diagram of a structure of an hardware of the electronic device of the interaction control method for virtual reality according to an embodiment of the disclosure, as shown in FIG. 9, the device includes:

one or more processors 910 and a memory 920, in FIG. 9, one processor 910 is employed as an example.

The electronic device of the interaction control method for virtual reality may further include: an input apparatus 930 and an output apparatus 940.

The processor 910, the memory 920, the input apparatus 930 and the output apparatus 940 may be connected via a bus or other means, in FIG. 9, a connection via a bus is taken as an example.

As a nonvolatile computer readable storage media, the memory 920 can be used to store nonvolatile software program, nonvolatile computer executable program and module, such as the program instructions/modules corresponding to the interaction control method for virtual reality in the embodiments of the present application (e.g., the display module 601, the determination module 602, the execution module 603 and the closing module 604 as shown in FIG. 6). The processor 910 executes various functions and applications of a server and data processing by running a nonvolatile software program, instructions and a module stored in the memory 920, so as to carry out the interaction control processing method for virtual reality in the embodiments above.

The memory 920 may include a program storage area and a data storage area, wherein the program storage area can store an operating system, an application program required for at least one function; the data storage area can store the data created based on the use of the interaction control processing device for virtual reality, or the like. Further, the memory 920 may include high-speed random access memory, and may further include nonvolatile memory, such as at least one disk storage device, flash memory device, or other nonvolatile solid-state memory devices. In some embodiments, the memory 920 optionally includes a memory remotely located with respect to the processor 910, which may be connected to an interaction control processing device for virtual reality via a network. Examples of such network include, but not limited to, Internet, Intranet, local area network (LAN), mobile communication network, and combinations thereof.

The input apparatus 930 may receive the input numbers or characters information, as well as key signal input associated with user settings of the interaction control processing device for virtual reality and function control. The output apparatus 940 may include a display screen or other display device.

The one or more modules are stored in the memory 920, and when being executed by the one or more processors 910, execute the interaction control processing method for virtual reality according to any one of the foregoing embodiments of methods.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players (for example iPod), video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

In the embodiments provided in this application, it should be understood that the disclosed device and method may be realized through other ways. For example, the device embodiments described above are exemplary simply; for example, the division of module is a division of logical functions simply, and can select other division methods during actual implementation; for example, a plurality of modules or components may be combined or integrated into another system, or some features may be neglected, or not executed. In addition, the mutual coupling, or direct coupling, or communication connection between the displayed or discussed components might be realized through some interfaces; the direct coupling or communication connection between devices or modules might be electrically, mechanically or in other forms.

The module described as a separate component may be or may not be physically separated; the component, displayed as a module, may be or may not be a physical module, that is, it may be located at one place, or may be distributed on multiple network modules. Part or all modules may be selected to realize the purpose of the embodiment scheme according to actual needs.

In addition, each function module in each embodiment of the disclosure may be integrated in a processing module, or exist as a physical module separately, or two or more modules are integrated in a module. The above integrated modules may be realized in the form of hardware, or in the form of software function module.

When the integrated modules are realized in the form of software function modules and are sold or used as an independent product, they can be stored in a computer readable storage medium. Based on this understanding, the technical scheme of the disclosure or the part making a contribution to the existing technology or part or all of the entire technical scheme on essence may be embodied in the form of software product. This computer software product is stored in a storage medium, including a number of instructions that enable a computer device (which may be a computer, a server or a network device, etc.) to execute all or part steps of the methods described in each embodiment of the disclosure. The aforementioned storage medium includes: USB flash disk, mobile hard disk, Read-Only Memory (ROM), Random Access Memory (RAM), diskette or compact disc and various mediums that can store program codes.

It should be noted that, for simple description, the method embodiments described above are expressed as a combination of a series of actions. However, those skilled in the art should understand that the disclosure is not limited by the execution order of the described actions, because some steps may be executed in a different order or simultaneously according to the disclosure. Next, those skilled in the art should also understand that all embodiments described in the specification are preferred embodiments and not all actions and modules involved in the embodiments are necessary to the disclosure.

Each of the above embodiments has a different focus in description; for the part not detailed in one embodiment, please refer to relevant description in other embodiments.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. An interaction control method for virtual reality, which is applied to a head-mounted display device, comprising:
if a time of a locating crosshair staying on an operation object on a virtual reality display interface is detected to be greater than or equal to a preset time value, displaying a selection interface corresponding to the operation object, the selection interface comprising a first area configured to confirm the selection of the operation object and a second area configured to cancel the selection of the operation object;
determining whether a user selects the first area or the second area according to the acquired head movement data of the user or the acquired eye image data of the user;
if the user is determined to select the first area, selecting the operation object; and
if the user is determined to select the second area, closing the selection interface.

2. The interaction control method according to claim 1, wherein the preset time value is 1 s to 2 s.

3. The interaction control method according to claim 1, wherein determining whether a user selects the first area or the second area according to the acquired head movement data of the user comprises:
processing the acquired head movement data of the user to determine the movement direction of the head;
if the movement direction of the head points to the direction of the first area, determining that the user selects the first area; and
if the movement direction of the head points to the direction of the second area, determining that the user selects the second area.

4. The interaction control method according to claim 1, wherein determining whether a user selects the first area or the second area according to the acquired eye image data of the user comprises:
determining the current position of the locating crosshair and the action executed by the eyes according to the acquired eye image data of the user;
if the current position of the locating crosshair is in the first area and the action executed by the eyes is consistent with a preset selection action, determining that the user selects the first area, wherein the preset selection action is to blink once or blink twice continuously;
if the current position of the locating crosshair is in the second area and the action executed by the eyes is consistent with a preset selection action, determining that the user selects the second area.

5. The interaction control method according to claim 1, wherein the selecting the operating object comprises:
if the operation object is an icon of an application, starting the application;
if the operation object is a virtual button or an action bar, simulating the operation of clicking the virtual button or action bar;
if the operation object is an icon of a video file, an icon of an audio file or an icon of a text file, playing the video file or the audio file, or opening the text file.

6. An interaction control electronic device for virtual reality, comprising:
one or more processors; and
a memory; wherein,
the memory is stored with instructions executable by the one or more processors, the instructions are configured to execute:
if a time of a locating crosshair staying on an operation object on a virtual reality display interface is detected to be greater than or equal to a preset time value, displaying a selection interface corresponding to the operation object, the selection interface comprising a first area configured to confirm the selection of the operation object and a second area configured to cancel the selection of the operation object;
determining whether a user selects the first area or the second area according to the acquired head movement data of the user or the acquired eye image data of the user;
if the user is determined to select the first area, selecting the operation object; and
if the user is determined to select the second area, closing the selection interface.

7. The electronic device according to claim 6, wherein the preset time value is 1 s to 2 s.

8. The electronic device according to claim 6, wherein determining whether a user selects the first area or the second area according to the acquired head movement data of the user comprises:
processing the acquired head movement data of the user to determine the movement direction of the head;
if the movement direction of the head points to the direction of the first area, determining that the user selects the first area; and
if the movement direction of the head points to the direction of the second area, determining that the user selects the second area.

9. The electronic device according to claim 6, wherein determining whether a user selects the first area or the second area according to the acquired eye image data of the user comprises:
determining the current position of the locating crosshair and the action executed by the eyes according to the acquired eye image data of the user;
if the current position of the locating crosshair is in the first area and the action executed by the eyes is consistent with a preset selection action, determining that the user selects the first area, wherein the preset selection action is to blink once or blink twice continuously;
if the current position of the locating crosshair is in the second area and the action executed by the eyes is consistent with a preset selection action, determining that the user selects the second area.

10. The electronic device according to claim 6, wherein the selecting the operating object comprises:
if the operation object is an icon of an application, starting the application;
if the operation object is a virtual button or an action bar, simulating the operation of clicking the virtual button or action bar;
if the operation object is an icon of a video file, an icon of an audio file or an icon of a text file, playing the video file or the audio file, or opening the text file.

11. A nonvolatile computer storage media, which has computer executable instructions stored thereon, wherein the computer executable instructions are configured to:
if a time of a locating crosshair staying on an operation object on a virtual reality display interface is detected to be greater than or equal to a preset time value, display a selection interface corresponding to the operation object, the selection interface comprising a first area configured to confirm the selection of the operation object and a second area configured to cancel the selection of the operation object;
determine whether a user selects the first area or the second area according to the acquired head movement data of the user or the acquired eye image data of the user;
if the user is determined to select the first area, select the operation object; and
if the user is determined to select the second area, close the selection interface.

12. The nonvolatile computer storage media according to claim 11, wherein the preset time value is 1 s to 2 s.

13. The nonvolatile computer storage media according to claim 11, wherein the determine whether a user selects the first area or the second area according to the acquired head movement data of the user comprises:
process the acquired head movement data of the user to determine the movement direction of the head;
if the movement direction of the head points to the direction of the first area, determine that the user selects the first area; and
if the movement direction of the head points to the direction of the second area, determine that the user selects the second area.

14. The nonvolatile computer storage media according to claim 11, wherein the determine whether a user selects the first area or the second area according to the acquired eye image data of the user comprises:
determine the current position of the locating crosshair and the action executed by the eyes according to the acquired eye image data of the user;
if the current position of the locating crosshair is in the first area and the action executed by the eyes is consistent with a preset selection action, determine that the user selects the first area, wherein the preset selection action is to blink once or blink twice continuously;
if the current position of the locating crosshair is in the second area and the action executed by the eyes is consistent with a preset selection action, determine that the user selects the second area.

15. The nonvolatile computer storage media according to claim 11, wherein the select the operating object comprises:
if the operation object is an icon of an application, start the application;
if the operation object is a virtual button or an action bar, simulate the operation of clicking the virtual button or action bar;
if the operation object is an icon of a video file, an icon of an audio file or an icon of a text file, play the video file or the audio file, or opening the text file.
